(19) United States
(12) Patent Application Publication
(10) Pub. No.: US 2012/0012614 A1
(43) Pub. Date: Jan. 19, 2012

(54) Beverage Additive Storage and Dispensing Station

(76) Inventors: Joshua Stuckey, Atmore, AL (US); Candy Stuckey, Atmore, AL (US)

(21) Appl. No.: 13/157,507

(22) Filed: Jun. 10, 2011

Related U.S. Application Data
(60) Provisional application No. 61/365,381, filed on Jul. 19, 2010.

(51) Int. Cl. B67D 7/74; B67D 7/80

(52) U.S. Cl. 222/129.3; 222/146.6

(57) ABSTRACT

A beverage flavor enhancer dispensing device designed for home or office use. The device is equipped with one, two or a plurality of chambers to retain liquids or powders that may be administered into a practitioner's beverage. Each chamber has a corresponding dispensing funnel, which when activated releases a portion of the loaded solution or powder into the beverage below. Further, the device is equipped with a cooling means, allowing the storage of perishable liquids such as cream or milk. The device may be of various sizes and have various numbers of chambers to suit practitioner preferences. Further, the device is equipped with a stirring means to ensure the administered enhancers are thoroughly mixed into the beverage.

### CROSS REFERENCE TO RELATED APPLICATION

This application claims the benefit of U.S. Provisional Application No. 61/365,381 filed on Jul. 19, 2010, entitled “Coffee Pit Stop.”

### BACKGROUND OF THE INVENTION

1. Field of the Invention

The present invention relates to a home or commercial cream and sugar-dispensing device for frequent coffee or tea drinkers.

Many consumers enjoy the taste of sugar, cream, and other flavor enhancers in their coffee and tea. Each of these additional substances, however, must be kept in separate containers, resulting in a cluttered table, countertop or refrigerator. Mixing devices, such as spoons and straws are necessary to mix the added flavor substances into drinks evenly. Further, these utensils are often placed on the table or countertop following an initial use for later reuse. Excess tea or coffee may drip from utensils and onto the tables and countertops, creating a mess and potentially resulting in unsightly stains. After consumers finish with their drinks, they must wash all the utensils, containers, and cups, along with the countertop itself. This can be an inconvenient, time-consuming process, especially for a frequent drinker or in a high traffic area.

With the growth of coffee consumption, used daily by millions of people, the need has arisen for a simple dispenser that for use in the home or office to permit one to readily prepare a cup of coffee with the desired amount of cream, sugar or other flavoring as desired. The present invention fulfils this need.

2. Description of the Prior Art

There are numerous prior art devices related to dispensing coffee or associated additives thereof. These prior art devices have several known drawbacks. Many of these devices prepare the coffee by internally mixing the coffee, sugar, and cream together. Other devices are suited for dispense powders such as instant coffee, powdered milk and sugar. The prior art devices do not allow the dispensation of liquids, and further, are tailored toward commercial or high volume locations.

Several of the prior art devices are directed to the dispensation of powdered materials, such as powdered creamer or sugar. Merman U.S. Pat. No. 3,946,913 is directed to a device for dispensing granulated material, comprising a container having sloped walls for retaining the material and feeding it into a plunger mechanism, which can be actuated manually to discharge a portion of the material from the container. Similarly, Agey U.S. Pat. No. 4,066,186 is directed to a dispenser for use in the home, office, or the like that includes housing means. The housing means includes a pair of storage chambers for containing coffee or the like in one chamber, with sugar, powdered milk or the like in another chamber. Each chamber has a discharge funnel terminating at an opening. A stand is coupled to the housing means for retaining the dispenser on a support surface and maintaining each opening above the support surface so that a cup may be placed beneath the openings. A triggered valve means dispenses the contents upon activation.

Additionally, King U.S. Pat. No. 4,974,751 is directed to a dual hopper coffee cream or product dispenser assembly that has two chambers in which spiral augers are mounted so as to selectively dispense one of two products. Agitators of generally gear-shape configuration are mounted in the hoppers and are driven by the spiral to agitate the product for positive and smooth delivery. Further, King U.S. Pat. No. 4,911,332 is directed to a sugar and cream dispenser for use with an automatic coffee machine, which prevents coffee or sugar from being dispensed into cups where the following customer does not desire cream or sugar. The cream and sugar chutes are provided with moveable doors, which are closed except when cream or sugar is to be dispensed into a cup. When the customer selects cream or sugar, the doors open so that the cream or sugar can be dispensed. At all other times the doors are closed, preventing accidental dispensation. The doors also prevent moisture and steam from passing up into the cream and sugar chutes causing crystallization of the contents and clogging of the machine.

The Merman, Agey and both King inventions each address the issue of dispensing powdered drink mixes or fixings. However, home consumers are generally more likely to desire liquid cream or creamer additives. As such, it is likely that these prior art devices are more suited for use in a commercial setting, where the consumer is not overly discriminating and where the products will be used in a relatively short time period to prevent spoilage.

Other patents are directed to commercial vending systems, typically mixing whole drinks internally. Tomiyama U.S. Pat. No. 4,319,698 is directed to an automatic vending machine of cups of cold drinks, with ice being directly placed into a cup, while source powder or a concentrated source liquid and cold water are included for mixture. An ice-making machine makes ice and cold water is prepared by cooling a source water supply with ice made by the ice-making machine. The cold water is mixed with the source powder or the concentrated source liquid and the mixture is guided to a cup together with the ice.

Similarly, Yamamoto U.S. Pat. No. 5,261,467 is directed to vending machine in which cups are stored for automatic release. When triggered, the cup supply unit drops a cup into a cup-holding unit and drink is injected thereinto as selected by a customer. The cup-holding unit holding the cup filled with drink is transported to the vending door, which opens to expose the upper portion of the cup to the customer, as if the cup were sitting on a counter table in the front of the vending machine. Additionally, Chigira U.S. Pat. No. 5,845,561 is directed to an apparatus for preparing a coffee beverage by supplying the ground coffee beans from a coffee mill to an extractor to prepare a coffee beverage.

Finally, Lassota U.S. Pat. No. 7,648,049 is directed to a mixing drink dispenser having a source of water for mixing with a beverage ingredient into a hopper to make a drink having a removable mixing chamber assembly for receipt of a beverage ingredient and water and mixing propellers. Further, the invention includes a lower section with a slanted bottom having a non-closable beverage outlet for unobstructed passage of the freshly mixed beverage out of the mixing chamber assembly and into a beverage container.

The Toniyama, Yamamoto and Lassota inventions are directed to machines capable of preparing a drink from a powdered mix entirely within their internal structure. Such devices are impractical and undesirable in the home, and are more appropriate for commercial use. Further, such inventions fail to address the issue addressed by the present invention, namely a device for providing a liquid or powder additive dispenser for home or commercial usage.

### SUMMARY OF THE INVENTION

In view of the foregoing disadvantages inherent in the known types of coffee preparation dispensers and devices now present in the prior art, the present invention provides a new coffee fixing dispenser wherein the same can be utilized for providing convenience for the user when preparing cups of coffee or tea for consumption.

The present invention is a device that dispenses sugar, cream or flavoring into cups of coffee or tea. The device may feature a plurality of hoppers: one that holds sugar and another that holds cream. A practitioner places a cup of coffee beneath the spout of the appropriate hopper and depresses the dispense button, after which the desired coffee additive will be deposited into the cup. After the dispensation of the desired substance, the practitioner may place the cup under the stirring device and press a mix button to blend the drink, ensuring that the added substance has achieved even incorporation into the drink. Use of the present invention eliminates the need for consumers to use messy mixing straws and spoons while preparing coffee at cafeterias, buffet restaurants, and, most particularly in the home.

It is therefore an object of the present invention to provide a beverage-additive dispenser and preparer for use in the home, office, or the like. Further, the dispenser includes a housing means including one, two, or a plurality of storage chambers for containing sugar, cream or other flavorings. Each chamber is provided with a discharge funnel terminating at an opening. Further, one or more chambers may be provided with a cooling means to allow storage of perishable liquids such as cream or non-dairy liquid creamers. Still further, each chamber shall be equipped with a means to store either powder or liquid as desired by the practioner.

It is a further object of the present invention to provide an attached stirring means, which may be used to ensure equal distribution of beverage additives within the drink.

It is a further object of this invention to provide a beverage-fixing dispenser in various sizes, allowing the situation of the practitioner to dictate the necessary beverage size. Commercial or office locations may require a larger device, while a homeowner may value a smaller device to conserve usable counter space. It is a further object of the present invention to provide an energy efficient device that is easily cleanable. Each chamber and dispensation funnel should be easily removable and cleanable, along with the stirring means, for limiting spoilage, contamination and allowing the practitioner a variety of additives for a particular chamber.

Other objects, features and advantages of the present invention will become apparent from the following detailed description taken in conjunction with the accompanying drawings.

### BRIEF DESCRIPTIONS OF THE DRAWINGS

FIG. 1 is a perspective view of the present invention showing an embodiment comprising two chambers and a stirring means.

### DETAILED DESCRIPTION OF THE INVENTION

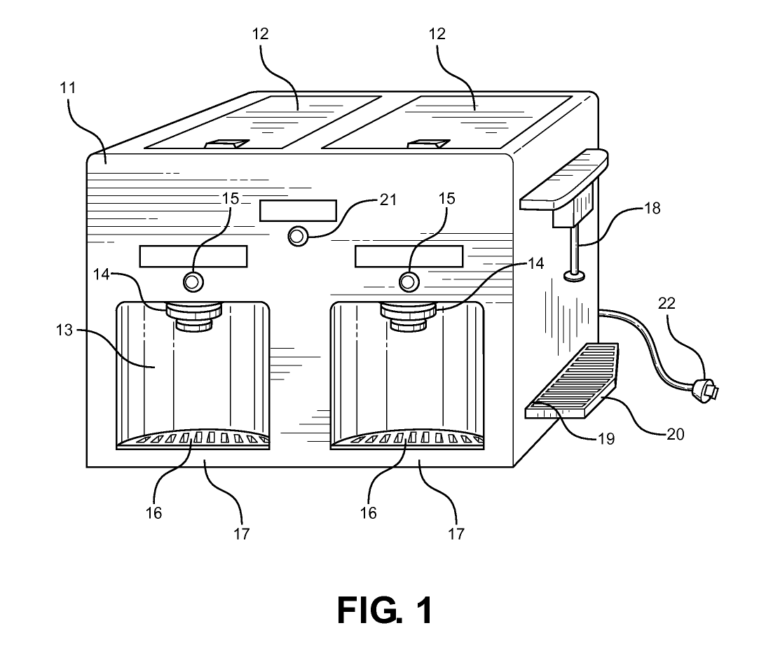

Referring now to FIG. 1, there is shown a perspective view of the present invention showing an embodiment comprising two chambers and a stirring means. The present invention comprises of a housing 11 containing one or more chambers as well refrigeration or other cooling means. The top of the housing 11 is equipped with access panels 12 to allow loading of powders or liquids into the chambers. On the front of the housing 11 and in front of each chamber is a chamber alcove 13 with a dispensing funnel 14 and a dispensing button 15 to activate dispensation of coffee or tea additives. Further, on the floor of each alcove is a removable grate 16 and tray 17 to catch any spilled fluids. Attached to the side of the housing 11 is a stirring means 18, as well as an extended grate 19 and liquid catch tray 20. The stirring means 18 is activated by a stirring activation button 21 located on the front of the housing 11. Further, the refrigeration and dispensation means within the housing receives electrical power via a standard wall outlet electrical power cord 22.

In use the present invention allows the addition of powder or liquid flavor enhancers, such as sugar, sweeteners, cream or creamers to coffee or tea without creating a mess or dirtying silverware. The present invention may comprise a machine housing 11 with one, two or a plurality of compartments designed to contain sugar, cream or other beverage fixings. Additives can be loaded into their respective compartments through access panels 12 located on the top of the housing. Dispensation funnels 14 are be located on the front of the housing 11 corresponding to each chamber. Cups may be placed beneath the appropriate dispensation funnel 11 and the corresponding dispensing button 15 may be pressed to dispense the desired substance. On a side of the machine extends a liquid catch tray 20 with a grate 19 located beneath a stirring means 18. A cup may be placed on the extended grate 19 of the liquid catch tray 20 and the stirring means may be placed into the beverage. Stirring occurs upon depression of the corresponding activation button 21 to evenly incorporate the flavor-enhancing substance or substances into the drink. Power is provided to the device via an electrical cord 22 that plugs into a traditional outlet.

Further, to maintain constant temperature and freshness, as well as allow perishable liquids to be stored, the housing 11 may be equipped with a cooling means, such as a refrigeration or similar cooling system. Further, the present invention may be embodied in multiple housing 11 sizes with multiple chamber sizes. Thus, allowing the optimal size to be selected for a given situation. Still further, the housing 11 may contain one, two or a plurality of chambers, each with chamber alcoves 13, dispensing funnels 14 and dispensing buttons 15. The chambers and dispensing funnels 14 of each chamber are designed to accommodate either liquids or solids. Further, the invention may have multiple dispensing buttons 15 per chamber to allow for different amounts to be dispensed. The implement that provides stirring means may be removable and replaceable as desired. Alternatively, a disposable variety may be utilized to prevent cross contamination of one drink to another, given different user's preferences, diets or allergies.

Operation and control of the present invention is possible via electronic actuation, electric motors, controllers and circuit electronics that receive input via the user and power from an external AC electrical outlet. Push button control from the user for specific functions is relayed to an electric circuit, which provides the logic for the desired function. For instance, when the dispensing button is depressed, a switch is closed to power a device that allows communication of flavor enhancer from a specific chamber, through the funnel, into the alcove and ultimately into a cup placed below. Once released, the button opens the same switch to deactivate the communication of flavor enhancer. The device that provides dispensation may take the form of a solenoid, a valve, a rotary mill or similar electromechanical device that allows controlled dispensation from a hopper and through an opening. Similarly, the stirring means may incorporate an electric motor that provides the motive force to rotate a stirring implement. Accessory functionality and control is also provided by internal electronics circuitry. Accessories may include a digital clock, a digital display to indicate a specific additive for a specific hopper/alcove, a digital readout of a measured amount to be dispensed, or control over the refrigeration means for a specific chamber. Refrigeration may or may not be required for a given additive, and may be controlled by the user via the imbedded electronics and exteriorly mounted control buttons on the housing.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A beverage additive dispensing and mixing machine, comprising:
a housing containing a plurality of chambers for holding beverage additives;
each chamber having a dispensing funnel for dispensation and communication of contents therefrom;
said dispensing funnel having a dispensing activation button, which when pressed releases said chamber contents through the funnel into a cup;
a stirring means for uniform mixing of said beverage additive in said cup.

2) A device as in claim 1, wherein said funnel is located within a dispensing alcove, said alcove being located above a grate and tray to catch spillage.

3) A device as in claim 1, wherein said beverage additive is of liquid or solid consistency.

4) A device as in claim 1, further comprising cooling means located within said housing, allowing for the storage of perishable liquids in said chambers.

5) A device as in claim 1, wherein said stirring means comprises a removable stirring implement for cleaning and replacement thereof.

6) A device as in claim 1, wherein said housing further comprises imbedded electronics for controlling said refrigeration means, said stirring means and said dispensing funnels.

7) A device as in claim 1, wherein said housing further comprises a plurality of digital screens for visualization of each chamber contents.

8) A beverage additive dispensing and mixing machine, comprising:
a housing containing a plurality of chambers for holding beverage additives;
said beverage additive is of liquid or solid consistency;
each chamber having a dispensing funnel for dispensation and communication of contents therefrom;
said funnel is located within a dispensing alcove, said alcove being located above a grate and tray to catch spillage;
said dispensing funnel having a dispensing activation button, which when pressed releases said chamber contents through the funnel into a cup;
a stirring means for uniform mixing of said beverage additive in said cup. said stirring means having an activation button, which when pressed initiates a rotation of a stirring implement;
a cooling means located within said housing, allowing for the storage of perishable liquids in said chambers.

9) A device as in claim 8, wherein said stirring implement is removable for cleaning and replacement thereof.

10) A device as in claim 8, wherein said housing further comprises imbedded electronics for controlling said refrigeration means, said stirring means and said dispensing funnels.

11) A device as in claim 8, wherein said housing further comprises a plurality of digital screens for visualization of each chamber contents.
